(19) United States
(12) Patent Application Publication
(10) Pub. No.: US 2004/0224297 A1
(43) Pub. Date: Nov. 11, 2004

(54) System and method for providing partial credit in an automatically graded test system

(76) Inventor: Marc Schwarzschild, New York, NY (US)

Correspondence Address: Steven I. Weisburd, DICKSTEIN SHAPIRO MORIN & OSHINSKY LLP, 1177 Avenue of the Americas, 41st Floor, New York, NY, 10036-2714, US

(21) Appl. No.: 10/434,112

(22) Filed: May 9, 2003

(51) Int. Cl. G09B 7/00

(52) U.S. Cl. 434/353

(57) ABSTRACT

A test maker accesses a test computer and inputs a question for a test. The test maker then inputs a plurality of acceptable answers for the question and an expression related to the question. The test maker then inputs acceptable values for each element in the expression and corresponding credit percentages. The test server determines an aggregate rubric of answers based on the answers and expression input by test maker and from transposes of these numbers. A test taker accesses the test and inputs his answers. The test server compares the answers of the test taker with the aggregate rubric and scores the test.

### FIELD OF THE INVENTION

The invention relates to software based testing systems and, more specifically, to a software based testing system which may provide partial credit for answers entered by a test taker.

### BACKGROUND OF THE INVENTION

Systems for providing software based testing systems are known in the art. In conventional systems, a test maker (e.g. a teacher) produces a test including a series of questions for a test taker (e.g. a student) and inputs the same into a test computer. The test maker further inputs a plurality of correct answers which correspond to the questions. A test taker reviews the questions and inputs his answers. The test computer then compares the test taker's answers with the test maker's answers and provides a test score.

In most conventional test taking systems, the software is not enabled to provide “partial” credit for certain questions. That is, the test maker inputs a single answer for each question and if an answer from the test taker to a particular question does not correspond exactly to the test maker's answer, the test taker receives no credit for that particular question. Clearly, such a system is somewhat draconian in that the test taker may have put in significant effort in producing his answer and may have even followed the necessary rules and understood the subject matter but made only a minor miscalculation.

Some prior art systems like that shown in U.S. Pat. No. 5,180,309 to Egnor, provide a more equitable approach. In the Egnor system if the test maker's answer is text, the system will assign partial credit if a threshold percentage of the characters of the test taker's answer corresponds to the test maker's answer. Additionally, if the test maker's answer is a number, partial credit is assigned to a plurality of numbers which are within a defined range of the correct answer.

However, even prior art systems like that shown in Egnor do not recognize or appreciate actual test situations. The idea behind assigning partial credit to a particular answer is that the exam taker did much of the work required for the correct answer and so demonstrated some knowledge regarding the tested material that the test taker deserves some credit greater than zero. If a test taker is familiar with the tested material, he frequently will produce an answer which is not near enough the correct answer as to fall within a defined threshold.

For example, a question may relate to the calculation of a force using the formula F=MA. In the correct answer, the correct numbers assigned to the variables may be 12 for mass M and 2 for acceleration A. A test taker may produce the correct acceleration of 2 and make a mistake in the mass and yield a value of 6. The test taker would then end up with a force of 12 instead of the correct answer of 24. The test taker clearly exhibited some knowledge of the material but due to a small error in the calculation of one variable (M), his answer may not be within a threshold of the correct answer.

In another example, the test taker may simply transpose the digits of his answer. For example, the correct answer may be 42 and a test taker may input an answer of 24. Here, the test taker had complete knowledge of the material and maybe even produced the correct answer but merely input a transposed answer into the testing interface. As 24 may also not be within a threshold range of 42, prior art systems like Egnor may assign no credit for such an answer.

Therefore, there is a need in the art for a software based testing system and method which can allocate partial credit to answers of an exam taker which may not necessarily within a defined threshold range of a single correct answer.

### BRIEF DESCRIPTION OF THE DRAWINGS

FIG. 1 is block diagram showing a testing system in accordance with the invention.

FIG. 2 is a flow chart showing the operation of a testing system in accordance with the invention.

### SUMMARY OF THE INVENTION

A test maker accesses a test computer and inputs a question for a test. The test maker then inputs a plurality of acceptable answers for the question and a mathematical expression related to the question. The test maker then inputs acceptable values for each element in the expression and corresponding credit percentages. The test server determines an aggregate rubric of answers based on the answers- and expression input by test maker and from transposes of these numbers. A test taker accesses the test and inputs his answers. The test server compares the answers of the test taker with the aggregate rubric and scores the test.

### DETAILED DESCRIPTION OF THE PREFERRED EMBODIMENT(S)

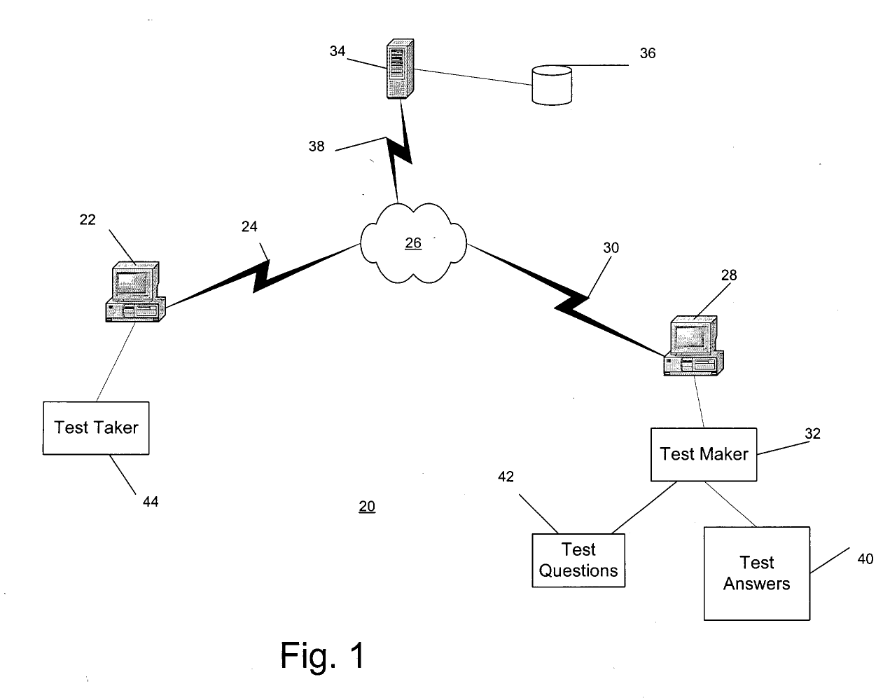

Referring to FIG. 1, there is shown a testing system 20 in accordance with the invention. Testing system 20 includes a test taker terminal 22 in communication with a network 26 through a communication link 24. A test maker terminal 28 is similarly in communication with network 26 through a communication link 30 and a test computer 34 is in communication with network 26 through link 38.

Network 26 can be any communication network, private or public. It should be noted that although terminals 22, 28 and computer 34 are shown as each coupled to a single communication network 26, this arrangement is shown merely for the convenience of aiding explanation of the present invention and is not limited to such. For example, communication network 26 can be comprised of the Internet, wide area network, or other public network and a private intranet coupled to the public network by network switches, firewalls, or other communication elements. The private intranet preferably includes an internal electronic mail system, web and application servers and the like.

Terminals 22, 28 and 34 are preferably comprised of any computer platform capable of running an Internet web browser or similar graphical user interface software. Examples of suitable web browsers include MICROSOFT's INTERNET EXPLORER and NETSCAPE's COMMUNICATOR. The computer platform can vary depending on the needs of the particular user and can range from a desktop or laptop personal computer or personal digital assistant (PDA) to a UNIX-based workstation or a mainframe computer.

Terminals 22, 28 and computer 34 preferably communicate with each other using the Transmission Control Protocol/Internet Protocol (TCP/IP) upon which particular subsets of that protocol can be used to facilitate communications. Examples include the Hypertext Transfer Protocol (HTTP), carrying Hypertext Mark-Up Language (HTML) web pages, Java applets and Active-X control programs and File Transfer Protocol (FTP). Computer 34 is capable of generating/retrieving the HTML pages and applets, and communicating them to terminals 22 and 28. For example, communication may take the form of files delivered using FTP or Extensible Mark-Up Language (XML) formats as agreed to by the sending and receiving users.

Terminals 22, 28 and computer 34 each preferably comprise a network interface (not shown) to couple to communication network 26, and include provisions for a website or other technology which can create a network presence from which the provider of computer 34 can interact with terminals 22 and 28. Technologies including hardware and software for establishing websites such as an Internet website are known.

Terminals 22, 28 and computer 34 preferably include one or more central processing units used to execute software code in order to control their operation read only memory, random access memory, and a storage device for storing programmatic code, databases and application data such as the hard drive, floppy disk drive, tape drive, CD-ROM or DVD-ROM.

Computer 34 can be comprised of any suitable processor arrangement designed to accommodate the expected number of users and transactions for the particular system in which these elements will be implemented. Known software languages and database technologies can be used to implement the described processes. Database 36 and programmatic code are stored in suitable storage devices within, or which have access to computer 34. The various components of computer 34 need not be physically contained within the same chassis or even located in a single location. For example, although database 36 is shown as a separate entity in FIG. 1, it is contemplated that database 36 can be implemented as part of a storage device within computer 34 or can even be coupled to computer 34 across a communication link. Database 36 is preferably a relational database or a multidimensional database which is analyzed using on-line analytical processing (OLAP) tools.

Data connections between terminals 22, 28 and network 26 can be any known arrangement for accessing a data communication network, such as dial-up Serial Line Interface Protocol/Point-to-Point Protocol (SLIP/PPP), Integrated Services Digital Network (ISDN), dedicated leased-line service, broadband (cable) access, Digital Subscriber Line (DSL), Asynchronous Transfer Mode (ATM), Frame Relay or other known access technique. Computer 34 is coupled to network 26 in a similar fashion. However, it is preferred that the link between computer 34 and network 26 be arranged such that access to computer 34 is always available.

The nature of the invention is such that one skilled in the art of writing computer executable code (software) would be able to implement the described functions using one or more popular computer programming languages such as “C++”, Visual Basic, Java or Perl. As used herein, references to displaying data on terminals 22 and 28 refer to the process of communicating data to the terminal across a network, and processing the data such that the data can be viewed on the terminal's screen using an Internet web browser or the like.

Terminals 22 and 28 are preferably equipped with web browser software which support frames, i.e., subdividing the display into multiple display sections, to allow the user to view different types of data in each of the different subareas. For example, user terminal 22 can display a main data area showing selected information and can simultaneously display a smaller area containing an index of other functions available within the website.

Referring still to FIG. 1, a test maker 32 accesses test maker terminal 28 and inputs test questions 42 and corresponding correct test answers 40. Questions 42 and correct test answers 40 are transmitted through communication link 30 to network 26 and on to test computer 34 through communication link 38. Test computer receives the test questions 42 and correct test answers 40 and stores both in database 36.

A test taker 44 interested in taking the test designed by the test maker 32 accesses test taker terminal 22 and instructs test taker terminal 22 to contact test computer 34 through network 26 to access test questions 42 stored in database 36. Test taker 44 reviews each question and enters what he thinks are the correct answers. These test taker answers are forwarded to test server 34. Test server 34 then compares the test taker answers with the correct test answers 40 and scores the test.

Each correct test answer 40 for each question includes a plurality of acceptable answers, each acceptable answer is allocated at least some partial credit. The acceptable answers are, unlike the prior art, non-consecutive numbers. For example, if the exact answer to a question is “42”, the test maker 32 may allocate 100% credit for “42” and perhaps also 100% credit or 80% credit to “24” as “24” is merely a transposing of the digits of “42”. Both “42” and “24” will be input by test maker 32 and respective credit allocations (e.g. 100% or 80%) will also be entered. In this way, if the test taker 44 produced the correct answer but simply transposed the digits, the test taker 44 will still receive at least partial, if not complete credit.

Additionally, each correct test answer 40 for each question may also include an expression or formula associated with the question. For example, suppose the question required determining the correct values for the variables “A” and “B” in the expression “A−B”. The test taker 44 will eventually enter a single number which is what he believes is the result of A−B. However, system 20 goes further than merely comparing the test taker's answer to A−B with the test maker's answer and actually looks into the question itself.

Continuing with the example, suppose that the correct value for “A” is 9824 and the correct value for “B” is 5632. Test maker 32 will enter, as part of correct test answer 40, the expression “9824-5632”. This expression is made of three elements, “9824”; “−”; and “5632”. Clearly, if test taker 44 enters a value of 4192 (9824−5632=4192), he will receive 100% credit. Additionally, test maker 32 also enters more acceptable values for each element and associated credit percentages.

In this case, test maker 32 will enter “9824-5632” as being allocated 100% credit. This yields “4192” is 100% credit. For the first element “9824”, test maker 32 may indicate that “9824” is allocated 100%, “17,578” is allocated 50% credit, “946” is allocated 50% credit, and “4548” may allocated 40% credit. The operand “−” may also be assigned different credit values. For example “−” may be given 100% credit whereas “+” may be given 40% credit. The significance of assigning different percentages to different operands will become clear below.

For the third element “5632”, “5632” is given 100% credit, “17,578” may be given 20% credit, “701” may be given 30% credit, and “8398” may be given 40% credit. Lastly, alternative answers, i.e. different from exact answer “4192” may be given partial credit. For example, “969” may be given 80% credit, “23” may be given 50% credit, and “910” may be given 50% credit. Test maker 32 has thus entered a rubric of possible answers 40 for a particular question 42.

Test server 34 now goes even further. Test server 34 analyzes the expression and the plurality of acceptable answers and associate credit percentages entered by the test maker for the expression, and produces an aggregate rubric of acceptable answers and corresponding credit percentages. Each acceptable value for each element is entered into the expression and the resultant answer and credit value is calculated. This is generally done by replacing each element, one at a time, and calculating the resultant answer and credit value. These answers are combined with the alternative answers to produce the aggregate rubric. Additionally, transposes, i.e. exchanges of digits, (typically two adjacent digits) of each value of each element are also entered into the expression to produce answers which are added to the aggregate rubric. Transposes of some of the answers are also added to the aggregate rubric. The aggregate rubric is shown immediately below for the example.

| Answer | −61,754 | −7,934 | −7,763 | −7,754 | −5,954 | −5,136 | −4,686 |
|---|---|---|---|---|---|---|---|
| Credit % | 20 | 20 | 20 | 20 | 20 | 50 | 50 |
| Answer | −4,668 | −1,174 | −1,084 | −1,048 | −184 | 23 | 32 |
| Credit % | 50 | 40 | 40 | 40 | 40 | 50 | 50 |
| Answer | 190 | 699 | 886 | 901 | 910 | 969 | 996 |
| Credit % | 50 | 80 | 40 | 50 | 50 | 80 | 80 |
| Answer | 1,426 | 1,435 | 3,292 | 3,652 | 4,192 | 4,201 | 4,210 |
| Credit % | 40 | 40 | 100 | 100 | 100 | 100 | 100 |
| Answer | 4,462 | 5,926 | 9,114 | 9,123 | 10,146 | 11,946 | 11,955 |
| Credit % | 100 | 40 | 30 | 30 | 50 | 50 | 50 |

| | | | |
|---|---|---|---|
| Answer | 12,126 | 15,456 | 65,946 |
| Credit % | 50 | 40 | 50 |

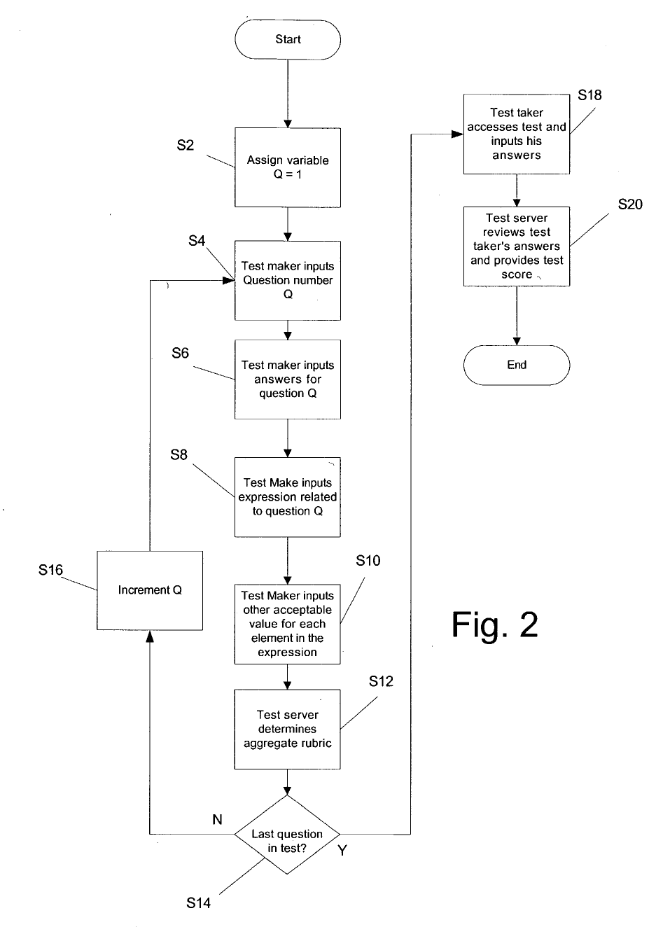

Referring now to FIG. 2, there is shown a flow chart detailing the operation of a possible use of testing system 20. Clearly, the steps could be performed in many possible orders and not every step need be done. At Step S2, a loop variable Q is assigned a value of 1 corresponding to the first question in a test. At Step S4, test maker 32 accesses test computer 34 and inputs a question 42 for a test corresponding to question number Q. At Step S6, test maker 32 inputs the correct answer and a plurality of alternative answers for question Q. At Step S8, test maker 32 inputs an expression related to question Q. At Step S10, test maker 32 inputs acceptable values for each element in the expression and corresponding credit percentages. At Step S12, test computer 34 determines an aggregate rubric of answers based on the expression and acceptable values for each element in the expression input by test maker 32.

At Step S14, server 34 queries whether test maker 32 has entered the last question for the test. If test maker 32 has not entered the last question, control branches to Step S16 where variable Q is incremented and then control goes back to Step S4 so that a new question and answers may be input and corresponding aggregate rubrics determined. If the last question has been entered, control branches to Step S118 where test taker 44 accesses the test and inputs his answers. Finally, at Step S20, test computer 34 compares the answers of the test taker with the aggregate rubric and scores the test.

Thus, by allowing a test maker to enter a plurality of alternative answers for a particular question along with partial credit allocations, a more equitable partial credit may be assigned for answers input by a test taker. Additionally, by allowing a test maker to input an expression associated with each question and to enter a plurality of acceptable values for each element in the expression, along with corresponding partial credit percentages, a more accurate allocation of partial credit for questions in a test is attained.

What is claimed is:

1. A testing system comprising:
a network;
a test maker computer in communication with the network; and
a test computer in communication with the network; wherein the test computer receives from the test maker:
a question; a plurality of distinct answers for the question, the answers being non-consecutive numbers, and a plurality of first credit allocations corresponding to the plurality of answers.

2. The system as recited in claim 1, where the test computer further receives from the test maker:
an expression related to the question, the expression including a plurality of elements;
a plurality of acceptable values for at least some of the elements; and
a plurality of second credit allocations corresponding to the plurality of acceptable values for each element.

3. The system as recited in claim 1, further comprising:
a test taker computer in communication with the network; and wherein:
a test taker coupled to the test taker computer forwards a request to the test computer through the network to answer the question;
the test taker further forwards a test taker answer for the question;
the test computer compares the test taker answer with the answers received from the test maker; and
the test computer grades the test taker answer using the first credit allocation.

4. The system as recited in claim 2, wherein
the test computer further:
calculates additional answers for the question by substituting the acceptable values for respective elements in the expression; and
calculates respective second credit allocations for the additional answers.

5. The system as recited in claim 4, wherein the test computer further:
produces transposed answers by transposing digits in the additional answers and in the plurality of distinct answers; and
produces an aggregate rubric based on the transposed answers, the additional answers, the plurality of distinct answers and the first and second credit allocations.

6. The system as recited in claim 5, further comprising:
a test taker computer in communication with the network; and
wherein a test taker coupled to the test taker computer forwards a request to the test computer through the network to answer the question;
the test taker further forwards a test taker answer for the question;
the test computer compares the test taker answer using the aggregate rubric; and
the test computer grades the test taker answer using the aggregate rubric.

7. A method for producing a test, the method comprising:
receiving a question from a test maker;
receiving a plurality of distinct answers for the question from the test maker, the distinct answers being non-consecutive numbers; and
receiving a plurality of first credit allocations corresponding to the plurality of distinct answers.

8. The method as recited in claim 7, further comprising:
receiving an expression related to the question, the expression including a plurality of elements;
receiving a plurality of acceptable values for at least some of the elements; and
receiving a plurality of second credit allocations corresponding to the plurality of acceptable values for each element.

9. The method as recited in claim 7, further comprising:
receiving a request from a test taker to answer the question;
receiving a test taker answer from the test taker for the question;
comparing the test taker answer with the answers received from the test maker; and
grading the test taker answer using the first credit allocations.

10. The method as recited in claim 8, further comprising:
calculating additional answers for the question by substituting the acceptable values for respective elements in the expression; and
calculating respective second credit allocations for the additional answers.

11. The method as recited in claim 10, further comprising:
producing transposed answers by transposing digits in the additional answers and in the plurality of distinct answers; and
producing an aggregate rubric based on the transposed answers, the additional answers, the plurality of distinct answers, and the first and second credit allocations.

12. The method as recited in claim 11, further comprising:
receiving a request from a test taker to answer the question;
receiving a test taker answer from the test taker for the question;
comparing the test taker answer with the aggregate rubric; and
grading the test taker answer using the aggregate rubric.

13. An aggregate rubric used in grading a test, the aggregate rubric being formed by the process of:
receiving a question from a test maker;
receiving an expression related to the question, the expression including a plurality of elements;
receiving a plurality of acceptable values for at least some of the elements;
receiving a plurality of first credit allocations corresponding to the plurality of acceptable values;
producing the aggregate rubric by substituting each of the acceptable values for corresponding elements in the expression and referring to corresponding first credit allocations.

14. The aggregate rubric as recited in claim 13, where the process further comprises:
receiving a plurality of distinct answers for the question from the test maker, the distinct answers being non-consecutive numbers;
receiving a plurality of second credit allocations corresponding to the plurality of distinct answers; and
producing the aggregate rubric using the plurality of distinct answers for the question and the second credit allocations.

15. A testing system comprising a test computer which receives from a test maker:
a question;
a plurality of distinct answers for the question, the answers being non-consecutive numbers; and
a plurality of first credit allocations corresponding to the plurality of answers.
